(19) United States
(12) Patent Application Publication
(10) Pub. No.: US 2022/0052344 A1
(43) Pub. Date: Feb. 17, 2022

(54) SODIUM-ION BATTERIES

(71) Applicant: FARADION LIMITED, Sheffield South Yorkshire (GB)

(72) Inventors: Ruth SAYERS, Sheffield South Yorkshire (GB); Jeremy BARKER, Chipping Norton Oxfordshire (GB); Ashish RUDOLA, Sheffield South Yorkshire (GB)

(21) Appl. No.: 17/413,046

(22) PCT Filed: Dec. 12, 2019
(86) PCT No.: PCT/GB2019/053519

§ 371 Date: Jun. 11, 2021

(30) Foreign Application Priority Data
Dec. 13, 2018 (GB) 1820358.8

(51) Int. Cl. H01M 4/587; H01M 10/054; H01M 10/056; H01M 4/36; H01M 10/44; H01M 10/058; H01M 4/485

(52) U.S. Cl. CPC H01M 4/587; H01M 10/054; H01M 10/056; H01M 2004/021; H01M 10/446; H01M 10/058; H01M 4/485; H01M 4/364

(57) ABSTRACT

The invention relates to a sodium-ion secondary cell comprising a cathode and an anode, wherein the cathode comprises one or more cathode electrode active materials which include at least one layered nickel-containing sodium oxide material, and the anode comprises a layer of anode electrode active material disposed on an anode substrate; where in the layer of anode electrode active material comprises at least one disordered carbon material, and the mass of the layer of anode electrode active material per square metre of the anode substrate is less than 80 gm⁻²-; further wherein the ratio of the mass of the cathode electrode active material to the mass of the layer of anode electrode active material is from 0.1 to 10, and wherein the thickness of the layer of anode electrode active material on the anode substrate is less than 100 μm.

### FIELD OF THE INVENTION

The present invention relates to sodium-ion secondary cells that exhibit excellent anode active material capacity and stable cycling performance. Further, the invention provides a method for the manufacture of these sodium-ion secondary cells, and a battery comprising such sodium-ion secondary cells.

### BACKGROUND OF THE INVENTION

Sodium-ion cells are analogous in many ways to the lithium-ion cells that are in common use today; they are both reusable secondary cells that comprise an anode (negative electrode), a cathode (positive electrode) and an electrolyte material, both are capable of storing energy, and they both charge and discharge via a similar reaction mechanism. When a sodium-ion (or lithium-ion) battery is charging, Na⁺ (or Li⁺) ions de-intercalate from the cathode and insert into the anode. Meanwhile charge balancing electrons pass from the cathode through the external circuit containing the charger and into the anode of the battery. During discharge the same process occurs but in the opposite direction.

Lithium-ion battery technology has enjoyed a lot of attention in recent years and provides the preferred portable battery for most electronic devices in use today; however, lithium is not a cheap metal to source and is considered too expensive for use in large scale applications. By contrast sodium-ion battery technology is seen to provide a number of advantages, not least because sodium is much more abundant than lithium and it is expected that this will provide a cheaper and more durable way to store energy into the future, particularly for large scale applications such as storing energy on the electrical grid. Work is currently underway to make sodium-ion batteries are a commercial reality.

One area that requires more attention is the design of the sodium-ion cells to optimise their electrochemical performance.

WO2017/073056 describes a method of passive voltage control in a sodium-ion battery as a way to achieve useful secondary sodium cells. Specifically, the method involves controlling the ratio of the mass of the negative electrode active material to the mass of the positive electrode active material to ensure that it is greater than 0.37 and less than 1.2. This equates to a cathode:anode active material mass ratio (herein referred to as ‘C/A mass balance’) in the range 0.833 to 2.70. Although not explicitly disclosed in WO2017/073056, it is understood from collaborations with the inventors of this prior art that they used anodes that contained 100-130 gm⁻² negative electrode active material per square metre of the anode substrate.

The aim of the present invention is to provide sodium-ion secondary cells that exhibit excellent anode and cathode active material capacity as well as stable cycling performance.

The sodium-ion secondary cells of the present invention will also be cost effective and straightforward to prepare. To this end, the Applicant has unexpectedly found that although using the C/A mass ratio in the range 0.833 to 2.70 goes some way to provide sodium-ion secondary cells with useful anode first desodiation capacities, it is possible to increase these anode capacities still further by choosing a C/A ratio in combination with other selected cell construction parameters. The Applicant explains and demonstrates these surprising results herein below.

The present invention therefore provides a sodium-ion secondary cell comprising a cathode and an anode, wherein the cathode comprises one or more positive electrode active materials and the anode comprises a layer, preferably a uniform layer, of negative electrode active material disposed on an anode substrate; wherein the layer of negative electrode active material comprises one or more disordered carbon-containing materials; characterised in that:
i) the mass of the layer of negative electrode active material ≤30 g per m² of the anode substrate,
ii) the ratio of the mass of the positive electrode active material to the mass of the layer of negative electrode active material is from 0.1 to 10; and
iii) the thickness of the layer of negative electrode active material on the anode substrate is 100 μm, preferably 80 μm.

For clarification, the units “gm⁻²” (grams per square metre) refers to the mass (g) of the active electrode material per unit area (m²) of the substrate, and it is also referred herein as “GSM”.

As used herein, “anode electrode active material” is equivalent to “negative electrode active material” and “cathode electrode active material” is equivalent to “positive electrode active material”.

As demonstrated in the specific examples below, the ratio of the mass of the cathode and anode electrode active materials is important, but the Applicant has found that it is the mass of the anode electrode active material that exerts an even greater control on the anode capacity results, with increasingly improved anode capacity results being observed as the mass of anode active material decreases relative to a constant mass of cathode electrode active material. Moreover, the Applicant has found that it is unfavourable to employ a mass of anode electrode active material of above 80 gm⁻², as Na plating problems can occur. Na plating is extremely undesirable due to a variety of reasons. Firstly, once Na plating occurs in the charging cycle (sodiation on the anode), it cannot be stripped efficiently in the discharging cycle in most of the commonly used sodium-ion electrolytes. This means that the coulombic efficiency of the cell would decrease with each such cycle and that the delivered cell capacity would also significantly and progressively decrease with each passing cycle where Na plating occurred (due to the loss of sodium from the cathode). Secondly, repeated Na plating during each charge cycle and inefficient stripping during the discharge cycle causes the Na metal deposited on the anode to develop a dendritic morphology which could short-circuit the battery internally, thereby causing an explosion. Obviously, this could be a significant safety hazard. Some of the most promising anode first de-sodiation capacity results (for example values of 270 mAh/g and higher) are achieved when the mass of the layer of negative electrode active material per square metre of the anode substrate is greater than 25 gm⁻² to less than 80 gm⁻², and the best anode first de-sodiation capacity results are achieved when the mass of the layer of negative electrode active material per square metre of the anode substrate is from 40 gm⁻² to 75 gm⁻², preferably from 40 gm⁻² to 65 gm⁻², and coincidently, the highest cycling stabilities (i.e. the lowest capacity fade per cycle) are also achieved when the mass of negative electrode active material per square metre is within these latter two ranges.

In particularly preferred sodium-ion secondary cells according to the present invention, the ratio of the mass of the positive electrode active material to the mass of the layer of negative electrode active material (i.e. the C/A mass balance) is from 0.5 to 10, preferably from 1.0 to 10, further preferably 1 to 5, ideally from 2.0 to 3.5 and especially preferably 2.0 to 2.75. Sodium-ion cells with a C/A mass balance within these preferred ranges exhibit very high anode first desodiation capacities as well as the further unexpected benefits of excellent cycling stability. The most favourable sodium-ion cells are those with a C/A ratio in the range of from 2.05 to 2.90 and which also contain a mass of anode electrode active material within the preferred ranges described.

During the production of secondary battery cells it is usual to form a layer of the anode or cathode electrode active material on a substrate, for example a current collector foil, and then to “calender” the coated substrate by passing the coated substrate through a series of rollers to achieve a uniform thickness of the electrode material on the substrate. In a typical sodium-ion cell, the post-calendering thickness of the anode electrode active material will be in the range 100 μm to 140 μm, and that of the cathode electrode active material will be 80-110 μm. Surprisingly, the present Applicant has found that for layers of anode electrode active materials of similar densities, there is a clear relationship between the ability of the sodium ions to be transported within the anode electrode active material during intercalation and de-intercalation on the one hand, and the thickness of the anode electrode active material, on the other. In particular, the present Applicant has observed that thinner layers of anode electrode active materials produce disproportionately and unexpectedly higher anode first de-sodiation capacities than thicker layers of anode electrode material with a comparable density. The thicknesses of the layer of negative electrode active material on the anode substrate used in the sodium-ion secondary cells of the present invention are described above, i.e. ≤100 μm, and preferably ≤30 μm.

The sodium-ion secondary cells according to the present invention may comprise any known positive electrode active material capable of the insertion and extraction of sodium ions. Suitable examples include metal sulphide compounds, such as TiS₂, metal oxide compounds, phosphate containing compounds, polyanion containing compounds, Prussian blue analogues and nickelate or non-nickelate compounds of the general formula:
A_{1±δ}M¹_{V}M²_{W}M³_{X}M⁴_{Y}M⁵_{Z}O_{2-c}
wherein
A is one or more alkali metals selected from sodium, potassium and lithium;
M¹ comprises one or more redox active metals in oxidation state +2, preferably one or more redox active metals in oxidation state +2 selected from nickel, copper, cobalt and manganese;
M² comprises a metal in oxidation state greater than 0 to greater than or equal to +4;
M³ comprises a metal in oxidation state +2;
M⁴ comprises a metal in oxidation state greater than 0 to less than or equal to +4;
M⁵ comprises a metal in oxidation state +3;
wherein
0≤δ≤1;
V iS >0;
W iS ≥0;
X is ≥0;
Y is ≥0;
at least one of W and Y is >0
Z iS ≥0;
C is in the range 0≤c<2

wherein V, W, X, Y, Z and C are chosen to maintain electrochemical neutrality.

Ideally, metal M² comprises one or more transition metals, and is preferably selected from manganese, titanium and zirconium; M³ is preferably one or more selected from magnesium, calcium, copper, tin, zinc and cobalt; M⁴ comprises one or more transition metals, preferably selected from manganese, titanium and zirconium; and M⁵ is preferably one or more selected from aluminium, iron, cobalt, tin, molybdenum, chromium, vanadium, scandium and yttrium. A cathode active material with any crystalline structure may be used, and preferably the structure will be O3 or P2 or a derivative thereof, but, specifically, it is also possible that the cathode material will comprise a mixture of phases, i.e. it will have a non-uniform structure composed of several different crystalline forms.

As discussed above, the negative electrode active materials anodes are carbon-based materials which have a disordered structure; advantageously, such materials lend themselves to the insertion and extraction of sodium ions during a charge/discharge process. The exact structure of the preferred carbon materials has still to be resolved, but in general terms it is ideal if it has a non-graphitizable, non-crystalline, amorphous carbon structure. Hard or soft carbons may be used but an anode comprising one or more “hard carbon” materials is particularly preferred. “Hard carbon” has layers, but these are not neatly stacked, and it has micropores/nanopores (micro-sized or nano-sized pores) formed between the disorderly stacked carbon layers. At the macroscopic level, hard carbon is isotropic. Typically, hard carbon suitable for anode use may be produced from carbon-containing starting materials, (such as sucrose, biomass, corn starch, glucose, organic polymers (e.g. polyacrylonitrile or resorcinol-formaldehyde gel), cellulose, petroleum coke, coal tar or pitch coke), first mixed with a thermoplastic binder such as a synthetic resin, and then heated to about 1200° C. Commercially available hard carbons include those sold by Kureha Corporation, Kuraray Chemical Company and Kureha Corporation.

The disordered carbon-based anode materials may be used alone, or in combination with any other suitable negative electrode (anode) active materials (referred to herein as further materials) capable of storing sodium ions may be employed in the sodium-ion cells according to the present invention. Such further materials may include metals, metal-containing compounds, metal alloys, non-metals and non-metal-containing compounds have been identified as high-capacity anodes, including Na₁₅Sn₄, Na₃Sb, Na₃Ge and Na₁₅Pb₄, or as a composite with one or more other materials, such as a non-metal, a metal or a metal alloy, which are capable of storing sodium ions as detailed above. The metal or non-metal may be in elemental or compound form. Particularly preferred anode active materials include hard carbon/X composite materials where X is one or more selected from: phosphorus, sulfur, indium, antimony, tin, lead, iron, manganese, titanium, molybdenum and germanium, either in elemental form or in compound form, preferably with one or more selected from oxygen, carbon, nitrogen, phosphorus, sulfur, silicon, fluorine, chlorine, bromine and iodine. X is preferably one or more selected from P, S, Sn, SnO, SnO₂, SnF₂, Fe₂O₃, Fe₃O₄, MoO₃, TiO₂, Sb, Sb₂O₃, SnSb and SbO.

Secondary carbon-containing materials may also be used in combination with the above mentioned anode active materials, interalia, to improve the conductivity of the anode, for example: activated carbon materials, particulate carbon black materials, graphene, carbon nano-tubes and graphite. Example particulate carbon black materials include those with a BET nitrogen surface area of around 62 m²/g, commercially available from Timcal Limited or carbon black materials with a BET nitrogen surface area of around <900 m²/g, preferably a BET nitrogen surface area of around 770 m²/g, which are available from Imerys Graphite and Carbon Limited as specialty carbons for rubber compositions. Carbon nano-tubes which have a BET nitrogen surface area of 100-1000 m²/g, graphene which typically has a surface area of around 2630 m²/g and activated carbon materials with a BET nitrogen surface area of >3000 m²/g may also be used.

Surprisingly, the positive effects on anode 1^{st} desodiation capacity as a result of using a mass of negative electrode active material per square metre of the anode substrate of 80 gm⁻², a C/A mass balance in the range 0.1 to 10 and a negative electrode active material thickness on the anode substrate of ≤100 μm, appear to be retained regardless of the composition of the electrolyte used in the cell, and regardless of the type of binder used when making the anode electrodes. These observations are demonstrated in the specific examples discussed below.

The present Applicant has also noted that when the sodium-ion secondary cells of the present invention are being charged such that the anode is being sodiated, a graph of anode active material capacity (mAh/g) on the x-axis against potential (V) versus Na/Na⁺ on the y-axis will produce a line that displays a steep negative gradient “slope” region (starting around 1.20-1.30 V at 0 mAh/g down to above 0.10 V vs Na/Na⁺) which then flattens (typically from around >0 to ˜0.10 V vs Na/Na⁺) to give a “plateau” region which is substantially parallel with the x-axis. Significantly, as the mass and the thickness of the active material on the anode decreases, the capacity originating from the ‘plateau’ region increases dramatically, as compared with the capacity originating from the ‘slope’ region. Moreover, the present Applicant has found that the relationship between the decreasing mass of anode active material and increasing anode specific capacities, is linear. It is remarkable that the thickness of the active material on the anode has such a direct influence over the reversible capacity of a sodium-ion cell and it is believed that this is the first time that such a phenomenon has been recognised.

As used herein, ‘plateau capacity’ is defined as the capacity contribution under ˜0.15 V (vs Na/Na⁺) in the de-sodiation curves of hard carbon anodes when cycled in 3E cells at a galvanostatic cycling rate of C/10 while the ‘slope capacity’ refers to the de-sodiation hard carbon anode active capacity between 0.15-2 V vs Na/Na+ in 3E cells at C/10 rate as well.

Notably, the sodium-ion secondary cells of the present invention are characterised by a particular range of plateau:slope capacity ratios of preferably 0 to 6:1, further preferably 0.5 to 5:1 and advantageously 1 to 5:1. The most preferred plateau:slope capacity ratio is 1.2 to 5.0:1 and ideally 1.4 to 4.75:1.

Thus, the sodium-ion secondary cells of the present invention are characterised by a plateau:slope reversible capacity ratio for the anode electrode active material, as derived from a plot of anode active material capacity (mAh/g) (x-axis) against cell potential (V) versus Na/Na⁺ (y-axis) measured in a three or more electrode full cell configuration, of 0 to 6:1, preferably 0.5 to 5:1, further preferably 1 to 5:1, particularly preferably 1.2 to 5.0:1 and ideally 1.4 to 4.75:1. A plateau reversible capacity of 0 mAh/g can be obtained by cycling a cell so that it does not reach the plateau region, for example by choosing a light C/A mass balance and/or de-rating the cell to say 3.7-1.V. A P:S ratio of 0 means that all of the capacity contribution will be as a result of the slope region.

In a further embodiment, the present invention provides a battery which comprises at least two sodium-ion secondary cells as described above, and preferably at least three sodium-ion cells.

In another further embodiment, the present invention provides a method of manufacturing a sodium-ion secondary cell according to the present invention comprising:
a) assembling a cathode comprising one or more positive electrode active materials, together with an anode comprising an anode substrate coated with a layer of negative electrode active material, and an electrolyte, to form a sodium-ion secondary cell, and
b) cycling the sodium-ion secondary cell to a first voltage;
characterised in that:
   i) the mass of the layer of negative electrode active material is ≤30 g per square metre of the anode substrate;
   ii) the ratio of the mass of the positive electrode active material to the mass of the layer of negative electrode active material is from 0.1 to 10; and
   iii) the thickness of the layer of negative electrode active material on the anode substrate is 100 μm.

The present Applicant has found another interesting and useful phenomenon which may be used to further improve the performance of sodium-ion secondary cells. When any pristine sodium-ion secondary cell undergoes its first charge/discharge cycle, an irreversible loss in capacity for the hard carbon anode of around 20% is observed, and a similar irreversible capacity is observed on the layered oxide active cathode material; this is known as the “first cycle loss” of the cell. Conventional cell preparation procedures remove the “first cycle loss” effects (so that they do not appear in a commercial cell) by employing formation cycles that apply a voltage (typically C/10 at 4.20-1.00 Volts) during the first four cell formation cycles and then use a lower voltage or the same voltage in subsequent (“Post” or “operation”) cell cycles (such as C/5 at 4.00-1.00, 4.10-1.00 or 4.20-1.00 Volts). As well as dealing with the first cycle loss, this procedure is also known to prolong the life-time of the cell. Surprisingly, the present applicant has found that further positive effects on the post-formation cycling stability can also be obtained when the “Post”-formation cycles (i.e. when the cell is in operation) are “de-rated”, that is, the “Post”-formation cycles are performed at C/5 at 4.00-1.00 Volts or 4.10-1.00 Volts instead of C/5 at 4.20-1.00 Volts. Additionally, the present Applicant has observed that performing the formation cycles at C/10 at 4.00-1.00 Volts (or C/10 at 4.10-1.00 Volts) rather than C/10 at 4.20-1.00 Volts and operating the cell at C/54.00-1.00 Volts (or C/5 at 4.10-10 Volts) achieves significant improvements to the cathode and anode capacities in the “Post-formation” (operation) cycles. Details of these observations are presented in the specific examples below.

As discussed above and as demonstrated in the specific examples below, the present applicant has found that low GSM effects of hard carbon are not brought about as a result of changes to the active material (type of hard carbon), binder or electrolyte, but only as a result of the GSM of the hard carbon used in the anode electrode, the C/A mass balance and the thickness of the anode material.

In a further embodiment of the present invention, there is provided a sodium-ion secondary cell comprising a cathode and an anode, wherein the cathode comprises one or more positive electrode active materials and the anode comprises a layer, preferably a uniform layer, of negative electrode active material disposed on an anode substrate; wherein the layer of negative electrode active material comprises one or more disordered carbon-containing materials;

characterised in that:
i) the mass of the layer of negative electrode active material ≤80 g per m² of the anode substrate,
ii) the ratio of the mass of the positive electrode active material to the mass of the layer of negative electrode active material is from 0.1 to 10;
iii) the thickness of the layer of negative electrode active material on the anode substrate is ≤100 μm, preferably ≤80 μm; and
iv) the layer of negative electrode active material has a volume specific surface area (VSSA) of above 0.8, preferably above 0.8 to 500, particularly preferably 0.8 to 400, ideally 0.8 to 300 and especially 0.8 to 200.

In a further aspect, the present invention provides a sodium-ion secondary cell comprising a cathode and an anode, wherein the cathode comprises one or more positive electrode active materials and the anode comprises a layer, preferably a uniform layer, of negative electrode active material disposed on an anode substrate; wherein the layer of negative electrode active material comprises one or more disordered carbon-containing materials; characterised in that the layer of negative electrode active material has a volume specific surface area (VSSA) of above 0.8, preferably above 0.8 to 500, particularly preferably 0.8 to 400, ideally 0.8 to 300 and especially 0.8 to 200.

### BRIEF DESCRIPTION OF THE DRAWINGS

The present invention will now be described with reference to the following figures in which:

FIG. 1 shows anode profiles of cycle 1 in 3E full cells using a nickelate-based Na_{0.833}Ni_{0.317}Mn_{0.467}Mg_{0.1}Ti_{0.117}O₂ cathode and commercial hard carbon anode (available from Kuraray Corporation) for potential (V versus Na/Na⁺) against the anode active specific capacity (mAh/g), using several of the different masses of anode active materials as detailed in Table 1.

FIG. 2 shows the effect of using different electrolytes on the anode profiles of cycle 1 in 3E full cells using a nickelate-based Na_{0.833}Ni_{0.317}Mn_{0.467}Mg_{0.1}Ti_{0.117}O₂ cathode and commercial hard carbon anode (available from Kuraray Corporation) for potential (V versus Na/Na⁺) against the anode active specific capacity (mAh/g) for anodes with similar active GSM values.

FIG. 3 shows the effect of using commercial hard carbon derived from anthracite on the anode profiles of cycle 1 in 3E full cells using a nickelate-based Na_{0.833}Ni_{0.317}Mn_{0.467}Mg_{0.1}Ti_{0.117}O₂ cathode for potential (V versus Na/Na⁺) against the anode active specific capacity (mAh/g) over a range of anode active GSMs.

FIG. 4 shows the effect of using commercial hard carbon derived from biomass on the anode profiles of cycle 1 in 3E full cells using a nickelate-based Na_{0.833}Ni_{0.317}Mn_{0.467}Mg_{0.1}Ti_{0.117}O₂ cathode for potential (V versus Na/Na⁺) against the anode active specific capacity (mAh/g) over two different anode active GSMs.

FIG. 5 shows the effect of using an aqueous binder in the hard carbon anode on the anode profiles of cycle 1 in 3E full cells using a nickelate-based Na_{0.833}Ni_{0.317}Mn_{0.467}Mg_{0.1}Ti_{0.117}O₂ cathode and commercial hard carbon anode (available from Kuraray Corporation) for potential (V versus Na/Na⁺) against the anode active specific capacity (mAh/g) over two different anode active GSMs

FIG. 6 shows a plot of anode active specific capacity (mAh/g) against cycle number to illustrate the long term cycling performance for 3E full cells using a nickelate-based Na_{0.833}Ni_{0.317}Mn_{0.467}Mg_{0.1}Ti_{0.117}O₂ cathode and commercial hard carbon anode (available from Kuraray Corporation) and using different anode active GSMs and C/A mass balances.

FIG. 7 shows a plot of cathode active specific capacity (mAh/g) against cycle number to illustrate the long term cycling performance for 3E full cells using a nickelate-based Na_{0.833}Ni_{0.317}Mn_{0.467}Mg_{0.1}Ti_{0.117}O₂ cathode and commercial hard carbon anode (available from Kuraray Corporation) and using different anode active GSMs and C/A mass balances.

FIG. 8 shows a graph of anode active specific capacity (mAh/g) against cycle number to illustrate the effect of de-rating and formation voltage window on the cathode (nickelate-based Na_{0.833}Ni_{0.317}Mn_{0.467}Mg_{0.1}Ti_{0.117}O₂) and anode active specific capacities and cycling stabilities using commercial hard carbon anode (available from Kuraray Corporation).

FIG. 9 shows a graph of potential (V versus Na/Na⁺) against anode active specific capacity (mAh/g) to illustrate what happens to the anode profiles at cycle 1 and cycle 4 at constant anode active GSM and near constant C/A mass balance values using a 3E full cell using a nickelate-based Na_{0.833}Ni_{0.317}Mn_{0.467}Mg_{0.1}Ti_{0.117}O₂ cathode and commercial hard carbon anode (available from Kuraray Corporation).

FIG. 10 shows the long term cycling of 1 Ah full cell FPC180905 using an anode that contains 54.20 GSM anode electrode active material and a C/A mass balance of 2.71 with the cathode being nickelate-based Na_{0.833}Ni_{0.317}Mn_{0.467}Mg_{0.1}Ti_{0.117}O₂ material and with the anode being commercial hard carbon (available from Kuraray Corporation).

FIG. 11 shows a graph of anode active specific capacity (mAh/g) versus anode active GSM using 3E full cells with a nickelate-based Na_{0.833}Ni_{0.317}Mn_{0.467}Mg_{0.1}Ti_{0.117}O₂ cathode and commercial hard carbon anode (available from Kuraray Corporation) and illustrates the effect of anode active GSM on the initial cycling stability.

FIG. 12 shows a graph of anode active specific capacity (mAh/g) versus C/A mass balance using 3E full cells with a nickelate-based Na_{0.833}Ni_{0.317}Mn_{0.467}Mg_{0.1}Ti_{0.117}O₂ cathode and commercial hard carbon anode (available from Kuraray Corporation) and illustrates the effect of C/A mass balance on the stability of cycling.

FIG. 13 shows a graph of cathode active specific capacity (mAh/g) versus cycle number for a sodium ion cell with a Na_{0.833}Fe_{0.200}Mn_{0.483}Mg_{0.0417}Cu_{0.225}O₂ cathode material and a commercial hard carbon (available from Kuraray Corporation) 40.25 GSM active anode.

FIG. 14 shows a plot of potential (V versus Na/Na⁺) against the anode active specific capacity (mAh/g) for the performance of two cells using an HC/Fe₂P anode active material and a nickelate-based Na_{0.833}Ni_{0.317}Mn_{0.467}Mg_{0.1}Ti_{0.117}O₂ cathode, and comparing the anode active specific capacities for these cells when the active anode material is used at a mass of 74.27 gm⁻² in one cell (PCFA614) and 55.25 gm⁻² in the other cell (711042).

FIG. 15 shows a plot of potential (V versus Na/Na⁺) against the anode active specific capacity (mAh/g) for the performance a 3E full cell using an HC anode active material and a nickelate-based Na_{0.833}Ni_{0.317}Mn_{0.467}Mg_{0.1}Ti_{0.117}O₂ cathode, in which the anode active material is used at a mass of 52.2 gm⁻² and the cell uses a mass balance of 1.596.

FIG. 16 shows a plot of potential (V versus Na/Na⁺) against the anode active specific capacity (mAh/g) for the performance a 3E full cell using an HC anode active material and a pre-sodiated TiS₂ cathode, in which the anode active material is used at a mass of 62.9 gm⁻² and the cell uses a mass balance of 0.918.

FIG. 17 shows a plot of potential (V versus Na/Na⁺) against the anode active specific capacity (mAh/g) for the performance of a cell using an HC anode active material and an oxygen-deficient nickelate-based Na_{0.833}Ni_{0.317}Mn_{0.467}Mg_{0.1}Ti_{0.117}O_{2-δ} cathode, in which the anode active material is used at a mass of 52.9 gm⁻² and the cell uses a mass balance of 2.86.

FIG. 18 shows a plot of capacity retention (%) against cycle number for the first charge of two 3E Full comparative cells (A3PC231 and A3PC225) and two 3E full cells according to the present invention (A3PC268 and AC3PC238).

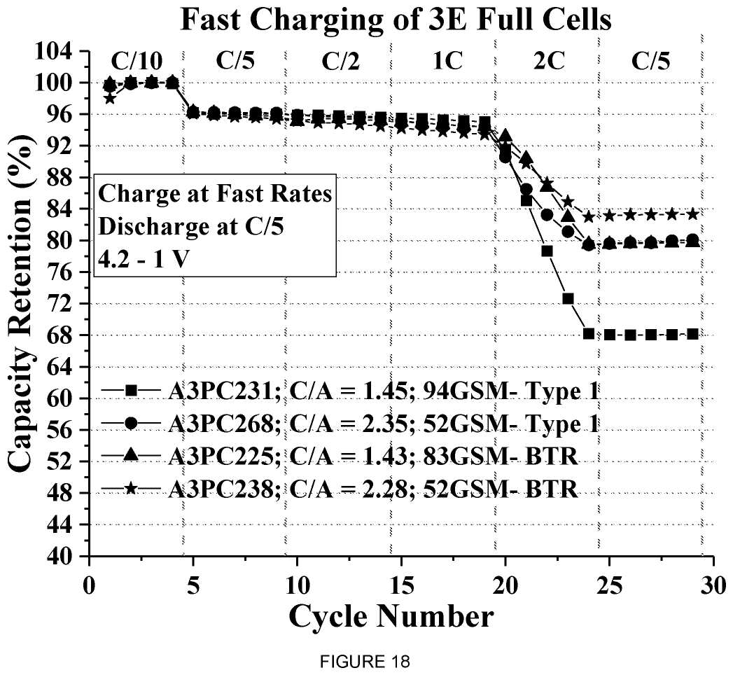

### DETAILED DESCRIPTION

Method for Making Sodium-Ion Cells According to the Present Invention

Sodium-ion cells according to the present invention were made using the following example method:

The positive electrode is prepared by solvent-casting a slurry of the active material, conductive carbon, binder and solvent onto a substrate. The conductive carbon used is commercially available from Timcal Limited. Polyvinylidene fluoride (PVdF) is used as the binder, and N-methyl-2-pyrrolidone (NMP) is employed as the solvent. The slurry is cast onto aluminium foil and heated until most of the solvent evaporates and an electrode film is formed. The electrode is then dried under dynamic vacuum at about 120° C. The electrode film contains the following components, expressed in percent by weight: 89% active material (doped nickelate-containing composition), 5% conductive carbon, and 6% PVdF binder.

The negative electrode is prepared by solvent-casting a slurry of the hard carbon active material (for example commercially available from Kuraray Corporation), conductive carbon, binder and solvent onto a substrate. The conductive carbon used is commercially available for example from Timcal Limited. PVdF is used as the binder (unless otherwise stated in the specific examples), and N-Methyl-2-pyrrolidone (NMP) is employed as the solvent. The slurry is cast onto aluminium foil and heated until most of the solvent evaporates and an electrode film is formed. The electrode is then dried further under dynamic vacuum at about 120° C. In all of the cells tested in this work the negative electrode film contains the following components, expressed in percent by weight: 88% active material, 3% conductive carbon, and 9% PVdF binder or 92% active material, 2% conductive carbon, and 6% PVdF binder. No practical difference in the electrochemistry was observed between these electrode formulations.

Prior to cell fabrication, the cathode and anode electrodes are both calendered, and dried again overnight at dynamic vacuum. Both electrodes are then placed inside pouches in an argon filled glove box (amounts of O₂ and H₂O present are under 5 ppm). For three-electrode (3E) cells, two separator layers are used while for two-electrode (2E) cells, only one separator layer is used. Except where indicated in Table 1 below, all of the cells use the generic polyethylene separator, for example available from Asahi Kasei. For the 3E cells, a piece of Na metal is placed in between the two separator layers and between the cathode and anode such that the Na piece is not inside the footprint of the anode and/or cathode. The cell assembly is then filled with electrolyte which, except where indicated in Table 1 below, is 0.5 m NaPF₆ in EC:DEC:PC=1:2:1 wt/wt, and also except where indicated in Table 1 below, all of the cells use a nickelate-based cathode active material, Na_{0.833}Ni_{0.317}Mn_{0.467}Mg_{0.1}Ti_{0.117}O₂ with the anode being commercial hard carbon (available, for example, from Kuraray Corporation). Finally, the pouch is sealed inside the glove box using a vacuum sealer. The cell is now ready for electrochemical testing.

Cell Testing

The cells are tested as follows using Constant Current Cycling techniques.

The cell is galvanostatically cycled at a given current density between pre-set voltage limits. A commercial battery cycler from MTI Inc. (Richmond, Calif., USA) or from Maccor Inc. (Tulsa, Okla., USA) is used. On charge, alkali ions are extracted from the cathode and inserted into the X/hard carbon anode material. During discharge, alkali ions are extracted from the anode and re-inserted into the cathode active material.

A number of sodium-ion cells were prepared using the above method, and Table 1 below presents the 3E cycling results using different ranges of active anode GSMs, thicknesses and C/A mass balances. The plateau capacity:slope capacity ratio (P:S ratio) is also indicated. Two-electrode (2E) cell data is also presented.

TABLE 1

| | | | | | | | | |
|---|---|---|---|---|---|---|---|---|
| | | | | C/A | Anode 1^{st} | Anode 1^{st} | Anode 1^{st} | Plateau: |
| | | Anode | Anode | Mass | Desodiation | Desodiation | Desodiation | Slope |
| S. | | Active | Thickness | Balance | Cap in 3E | Plateau Cap | Slope Cap | Capacity |
| No. | Cell Ref | GSM | (um) | Full Cell | (mAh/g) | (mAh/g) | (mAh/g) | Ratio |

Nickelate (Na_{0.833}Ni_{0.317}Mn_{0.467}Mg_{0.1}Ti_{0.117}O₂)Cathode//Type 1 Hard Carbon Anode
using 0.5 m NaPF₆ in EC:DEC:PC (1:2:1 wt/wt)

| | | | | | | | | |
|---|---|---|---|---|---|---|---|---|
| 1. | A3PC127 | 17.11 | 24 | 7.09 | 516.19 | 424.39 | 91.8 | 4.62 |
| 2. | A3PC95 | 26.04 | 32 | 5.86 | 474.00 | 355.25 | 118.75 | 2.99 |
| 3. | A3PC80 | 24.90 | 31 | 7.37 | 519.98 | 430.00 | 89.98 | 4.78 |
| 4. | A3PC113 | 30.03 | 37 | 3.96 | 417.55 | 338.11 | 79.44 | 4.26 |
| 5. | A3PC79 | 31.74 | 39 | 4.27 | 423.43 | 320.79 | 102.64 | 3.13 |
| 6. | A3PC99 | 36.88 | 44 | 4.68 | 449.79 | 384.00 | 65.79 | 5.84 |
| 7. | A3PC116 | 44.29 | 54 | 2.67 | 319.85 | 209.67 | 110.16 | 1.90 |
| 8. | A3PC130 | 45.43 | 54 | 2.62 | 294.57 | 204.75 | 89.82 | 2.28 |
| 9. | A3PC118 | 51.82 | 65 | 2.31 | 272.10 | 150.00 | 122.1 | 1.23 |
| 10. | A3PC117 | 51.82 | 66 | 2.57 | 302.52 | 192.96 | 109.56 | 1.76 |
| 11. | A3PC129 | 52.36 | 73 | 2.62 | 306.76 | 205.42 | 101.34 | 2.03 |
| 12. | A3PC119 | 51.82 | 65 | 3.15 | 343.38 | 256.00 | 87.38 | 2.93 |
| 13. | A3PC140 | 51.64 | 66 | 3.27 | 365.14 | 276.00 | 89.14 | 3.09 |
| 14. | A3PC133 | 53.09 | 67 | 3.28 | 364.19 | 281.00 | 83.19 | 3.38 |
| 15. | A3PC103 | 52.27 | 68 | 3.41 | 378.88 | 305.11 | 73.77 | 4.14 |
| 16. | A3PC110 | 61.97 | 73 | 1.94 | 246.14 | 127.93 | 118.21 | 1.08 |
| 17. | A3PC114 | 62.54 | 73 | 2.12 | 260.54 | 152.11 | 108.43 | 1.40 |
| 18. | A3PC91 | 60.26 | 73 | 2.56 | 312.46 | 200.00 | 112.46 | 1.78 |
| 19. | A3PC96 | 61.59 | 74 | 2.76 | 325.31 | 213.43 | 111.88 | 1.91 |
| 20. | A3PC83 | 61.21 | 73 | 2.96 | 342.06 | 245.59 | 96.47 | 2.55 |
| 21. | A3PC93 | 60.26 | 72 | 3.73 | 354.53 | 287.08 | 67.45 | 4.26 |
| 22.* | A3PC14 | 86.55 | 109 | 1.92 | 235.04 | 110.75 | 124.29 | 0.89 |
| 23.* | A3PC42 | 85.64 | 107 | 2.19 | 261.99 | 137.11 | 124.88 | 1.10 |
| 24.* | A3PC151 | 83.27 | 105 | 2.64 | 334.88 | 219.00 | 115.88 | 1.89 |
| | | | | | (plated) | (includes | | (difficult |
| | | | | | | plated | | to |
| | | | | | | capacity) | | estimate |
| | | | | | | | | due to |
| | | | | | | | | plating) |

Different Electrolyte: 1 m NaBF₄ in Tetraglyme

| | | | | | | | | |
|---|---|---|---|---|---|---|---|---|
| 25. | A3PC47 | 29.27 | 32 | 6.32 | 518.03 | 380.00 | 138.03 | 2.75 |

Anthracite Hard Carbon

| | | | | | | | | |
|---|---|---|---|---|---|---|---|---|
| 26.* | A3PC64 | 103.98 | 120 | 1.83 | 195.89 | 102.00 | 93.89 | 1.09 |
| 27. | A3PC106 | 62.16 | 55 | 2.69 | 239.93 | 153.00 | 86.93 | 1.76 |
| 28. | A3PC107 | 51.51 | 47 | 3.38 | 299.76 | 243.00 | 56.76 | 4.28 |

BTR BHC-240 Hard Carbon

| | | | | | | | | |
|---|---|---|---|---|---|---|---|---|
| 29.* | A3PC143 | 81.36 | 110 | 1.87 | 242.19 | 143.00 | 99.19 | 1.44 |
| 30. | A3PC136 | 42.58 | 55 | 3.63 | 410.45 | 348.00 | 62.45 | 5.57 |

Different Binder: CMC + SBR Binder

| | | | | | | | | |
|---|---|---|---|---|---|---|---|---|
| 31.* | A3PC141 | 80.85 | 111 | 1.92 | 233.97 | 113.00 | 120.97 | 0.93 |
| 32. | A3PC120 | 59.04 | 73 | 2.62 | 319.75 | 207.00 | 112.75 | 1.84 |

Effect of De-rating: 4.00-1.00 V

| | | | | | | | | |
|---|---|---|---|---|---|---|---|---|
| 13. | A3PC140 | 51.64 | 66 | 3.27 | 365.14 | 276.00 | 89.14 | 3.09 |
| 33. | A3PC153 | 52.36 | 66 | 3.32 | 292.51 | 185.00 | 107.51 | 1.72 |

2E 10 mAh (Nominal) Cells

| | | | | | | | | |
|---|---|---|---|---|---|---|---|---|
| 34. | APFC67 | 63.30 | 73 | 2.38 | 286.88 | — | — | — |

2E 1 Ah (Nominal) Cells

| | | | | | | | | |
|---|---|---|---|---|---|---|---|---|
| 35.* | FPC171230 | 97.23 | 120 | 1.36 | 164.43 | — | — | — |
| | (heavy | | | | | | | |
| | anode | | | | | | | |
| | GSM) | | | | | | | |
| 36. | FPC181105 | 52.64 | 68.5 | 2.25 | 276.85 | | | |
| 37. | FPC181106 | 52.80 | 69 | 2.25 | 241.78 | | | |
| 38. | FPC181131 | 52.76 | 68.5 | 2.25 | 273.96 | | | |
| 39. | FPC180905 | 54.20 | 65 | 2.71 | 325.71 | | | |
| 40. | FPC181107 | 52.84 | 68.5 | 2.79 | 289.14 | | | |
| 42. | FPC181129 | 52.79 | 69 | 2.81 | 305.64 | | | |
| 43. | FPC181130 | 52.91 | 69 | 2.81 | 288.21 | | | |
| 44. | FPC181010 | 52.92 | 67 | 2.84 | 346.65 | | | |
| 45. | FPC181009 | 52.73 | 67 | 2.85 | 349.67 | | | |
| 46. | FPC180916 | 50.30 | 60 | 2.96 | 358.35 | | | |

Non-nickelate Cathode (Na_{0.833}Fe_{0.200}Mn_{0.483}Mg_{0.0417}Cu_{0.225}O₂) 2E Cells

| | | | | | |
|---|---|---|---|---|---|
| 47. | 811023 | 40.25 | 63 | 3.13 | 336.45 |

Faradion Hard Carbon/Fe₂P Composite Anodes: 3E 10 mAh (Nominal) Cells

| | | | | | | | | |
|---|---|---|---|---|---|---|---|---|
| 48. | PCFA614 | 74.27 | 81 | 1.93 | 241.87 | 167.00 | 74.87 | 2.23 |
| 49. | 711042 | 55.25 | 72 | 2.25 | 270.96 | 197.00 | 73.96 | 2.66 |

Nickelate (Na_{0.833}Ni_{0.317}Mn_{0.467}Mg_{0.1}Ti_{0.117}O₂)Cathode//Type 1 Hard Carbon Anode
using 0.5 m NaPF₆ in EC:DEC:PC (1:2:1 wt/wt) 3E Full Cell ± C/10

| | | | | | | | | |
|---|---|---|---|---|---|---|---|---|
| 50 | A3PC359 | 52.2 | 67 | 1.596 | 196.13 | 77.26 | 118.87 | 0.65 |

Non-nickelate cathode (Sodiated TiS₂)//Type 1 Hard Carbon Anode using 0.5 m
NaPF₆ in EC:DEC:PC (1:2:1 wt/wt) 3E Full Cell ± C/10

| | | | | | | | | |
|---|---|---|---|---|---|---|---|---|
| 51 | A3PC376 | 62.9 | 36 | 0.918 | 231.96 | 152.36 | 79.6 | 1.914 |

Oxygen deficient cathode (Na_{0.833}Ni_{0.317}Mn_{0.467}Mg_{0.100}Ti_{0.117}O_{2-δ}//Type 1 Hard Carbon
using 0.5 m NaPF₆ in EC:DEC:PC (1:2:1 wt/wt) 3E 10 mAh Full Cell; 4.2-1 V; ± C/10

| | | | | | | | | |
|---|---|---|---|---|---|---|---|---|
| 52 | A3PC400 | 52.9 | 62 | 2.86 | 318.37 | 201.92 | 116.45 | 1.73 |

Charge acceptance capability of Type 1 and BTR BHC-240-based hard carbon anodes
as a function of anode active GSM. The cells are 3E 10 mAh Full Cell; 4.2-1 V (the
capacities mentioned below are stated for the 4^{th} cycle which was cycled at ± C/10)

| | | | | | | | | |
|---|---|---|---|---|---|---|---|---|
| 53* | A3PC231 | 94.36 | 122 | 1.45 | 175.86 | 68.21 | 107.65 | 0.63 |
| 54 | A3PC268 | 52.91 | 72 | 2.35 | 290.66 | 194.38 | 96.28 | 2.02 |
| 55* | A3PC225 | 83.07 | 110 | 1.43 | 175.39 | 82.56 | 92.83 | 0.89 |
| 56 | A3PC238 | 52.84 | 68 | 2.28 | 283.58 | 204.58 | 79.00 | 2.59 |

The Examples marked * are comparative examples, i.e. the compositions tested are not according to the present invention.

The Effect of the Mass of Anode Electrode Active Material on Anode Active Material Capacity.

As illustrated by the results presented in Table 1 above, the anode active 1^{st} de-sodiation specific capacity (mAh/g) in a sodium-ion battery comprising 3E full cells is found to increase as the mass of the anode electrode active material decreases over the range from about 85 gm⁻² to around 20 gm⁻². Moreover, particularly high anode active 1^{st} de-sodiation specific capacities (up to more than 500 mAh/g) are obtained when a low anode active material mass (low GSM) is coupled with a high C/A mass balance ratio (for example, a C/A ratio in excess of 7). Surprisingly, when the mass the of anode active material is kept to around 52 gm⁻² (e.g. samples A3PC118, A3PC117, A3PC129, A3PC119, A3PC140, A3PC133 and A3PC103) the anode 1^{st} de-sodiation capacity increases from around 272 mAh/g to 379 mAh/g and this is understood to be as a result of increasing the C/A mass ratio from 2.31 to 3.41.

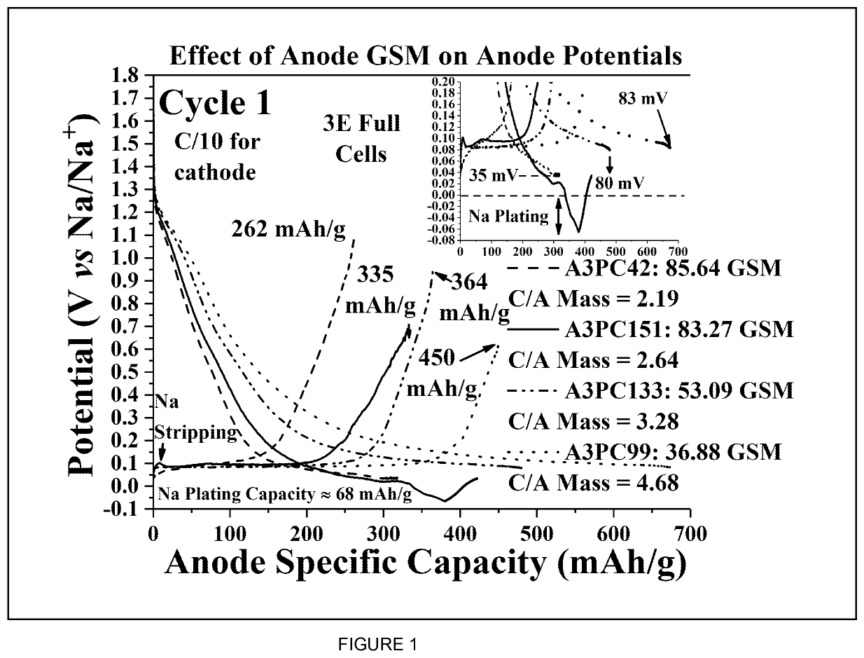

FIG. 1 illustrates the anode profiles in 3E full cells using different masses (GSMs) of hard carbon material (for example commercially available from Kuraray Corporation) and the C/A mass balance for each cell is indicated in the Figure. All cells used 0.5 m NaPF₆ in EC:DEC:PC=1:2:1 wt/wt as the electrolyte. The results not only again confirm that lighter GSM anodes deliver much higher capacity than the heavier GSM anodes, but also that the anode potential for the lighter GSM anodes when in their fully charged state is much higher than the heavier GSM anode potentials under corresponding charged conditions. This point is quite critical not only from a performance point of view, but also from a safety viewpoint: a higher anode absolute potential at the fully charged state means it is further away from ‘sodium plating potentials’ (under 0 V vs Na/Na⁺) thus rendering enhanced safety to the battery. These facts indicate that the lighter GSM anodes will provide useful advantages over heavier GSM anodes in a commercial setting.

FIG. 1 also illustrates that full cells which use heavy GSM anodes and a high C/A mass balance will disadvantageously lead to Na plating, and that this is particularly the case at low capacity values. Specifically, FIG. 1 shows that a full cell that uses 83.27 gm⁻² active anode material starts to exhibit Na plating at a sodiation capacity around 335 mAh/g in the first charge cycle of the full cell. The Na plating capacity is estimated to be around 68 mAh/g in the first sodiation process (this value corresponds to the portion of the anode cycling curve which was under 0 V vs Na/Na⁺) and this is apparent from a characteristic over-potential spike which is indicated by the arrow in FIG. 1. Although the observed first de-sodiation capacity for this cell is 335 mAh/g, when the Na plating capacity is taken into account, the effective first de-sodiation capacity resulting from sodium storage in the hard carbon active material will be reduced to between 267-300 mAh/g.

By contrast and discussed above, FIG. 1 confirms that the lighter GSM anode full cells deliver much higher de-sodiation capacities (364 or 450 mAh/g for the 53.09 or 36.88 GSM anodes respectively) at much higher fully charged anode potentials (around 80-83 mV).

It is concluded therefore that high GSM hard carbon anodes tend to induce Na plating in sodium-ion full cells and that this will occur at much lower capacity values than sodium-ion cells that use a lower mass of anode active material.

The Effect of Different Electrolytes on Anode Active Material Capacity.

An experiment was conducted to test whether the enhanced anode capacity for cells using a lower mass of anode active material is affected by the composition of the sodium-ion electrolyte used. Two cells (A3PC47 and A3PC80) were prepared, the former used an electrolyte that contained 0.5 m NaPF₆ in EC:DEC:PC in the ratio 1:2:1 wt/wt, and the latter used an ether-based electrolyte that contained 1 m NaBF₄ in tetraethylene glycol dimethyl ether (Tetraglyme).

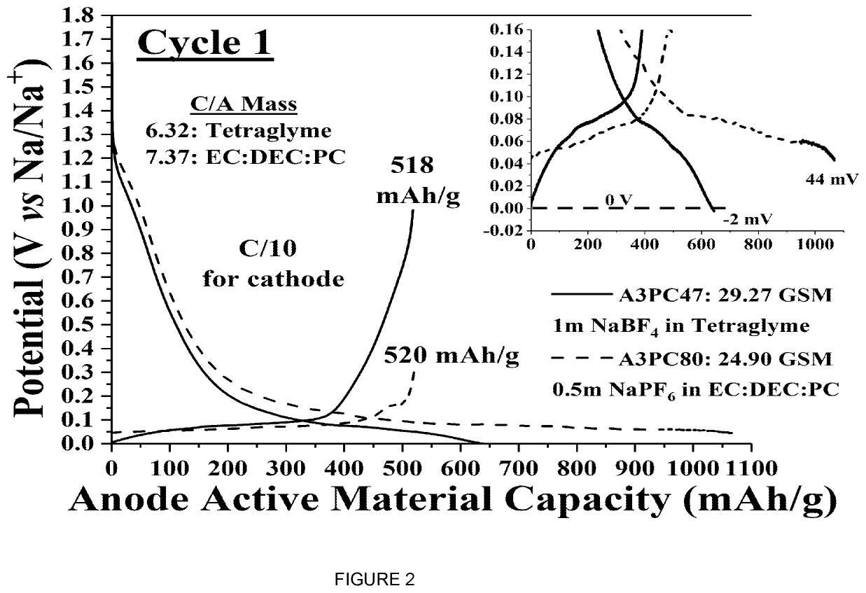

As illustrated in the FIG. 2, there is negligible difference in the anode profiles for the two 3E full cells A3PC47 and A3PC80; the former cell producing an 1^{st} de-sodiation anode capacity of 518 mAh/g for a 29.27 GSM active material hard carbon electrode, and the latter cell delivering a 1^{st} de-sodiation anode capacity of 520 mAh/g for a 24.90 GSM active hard carbon electrode.

It is concluded, therefore that the favourable anode capacity exhibited by cells that contain lower masses of anode electrode active material is independent of the sodium-ion electrolyte used.

The Effect of Using Different Hard Carbon Material on Anode Active Material Capacity.

Two further experiments were conducted to test whether anode first de-sodiation capacity is affected by the nature (composition and/or source) of anode electrode active material.

In the first of these experiments, three 3E full cells were prepared using a commercial hard carbon anode material derived from anthracite (a type of coal) sold under the trade name ‘Welsh Anthracite’ and available from Supaheat Fuels, with one cell (A3PC64) using 103.98 gm⁻² anode electrode active material, the other cell (A3PC106) using 62.16 gm⁻² anode electrode active material and the last cell (A3PC107) using 51.51 gm⁻² anode electrode active material.

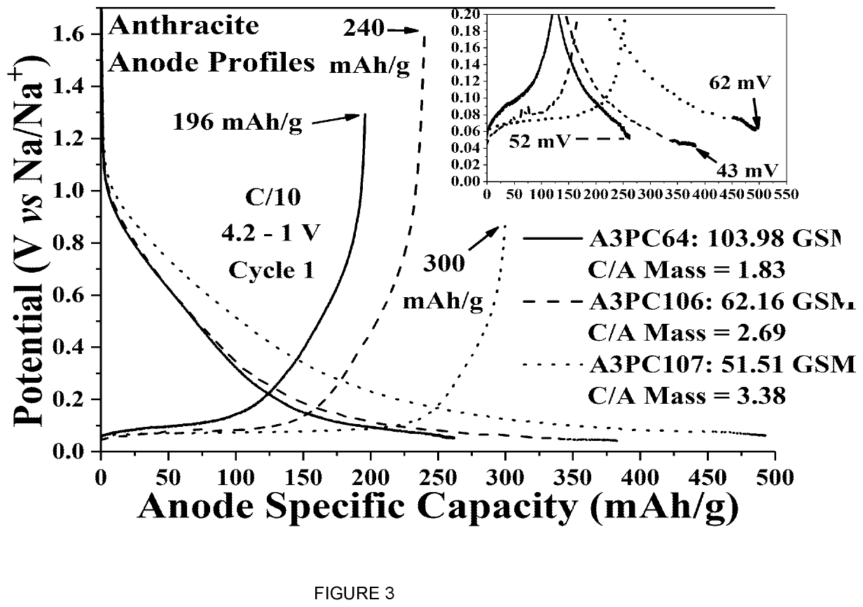

As shown in FIG. 3, and in line with the previous results discussed above, the anode capacity profile of the first cycle (300 mAh/g and 240 mAh/g) and the C/A mass balance values (3.38 and 2.69, respectively) are both higher in the case of the two 3E full cell that contain the lower masses of anode material (51.51 gm⁻² and 62.16 gm⁻², respectively) as compared against the anode capacity (196 mAh/g) and C/A mass balance value (1.83) for the cell with the higher mass of anode active material (103.98 gm⁻²).

In the second of these experiments, two 3E full cells were prepared using a commercial hard carbon anode material derived from biomass, sold under the trade name “BHC-240” grade by the Chinese company BTR. One cell (A3PC143) used 81.36 gm⁻² anode electrode active material and the other cell (A3PC136) used 42.58 gm⁻² anode electrode active material.

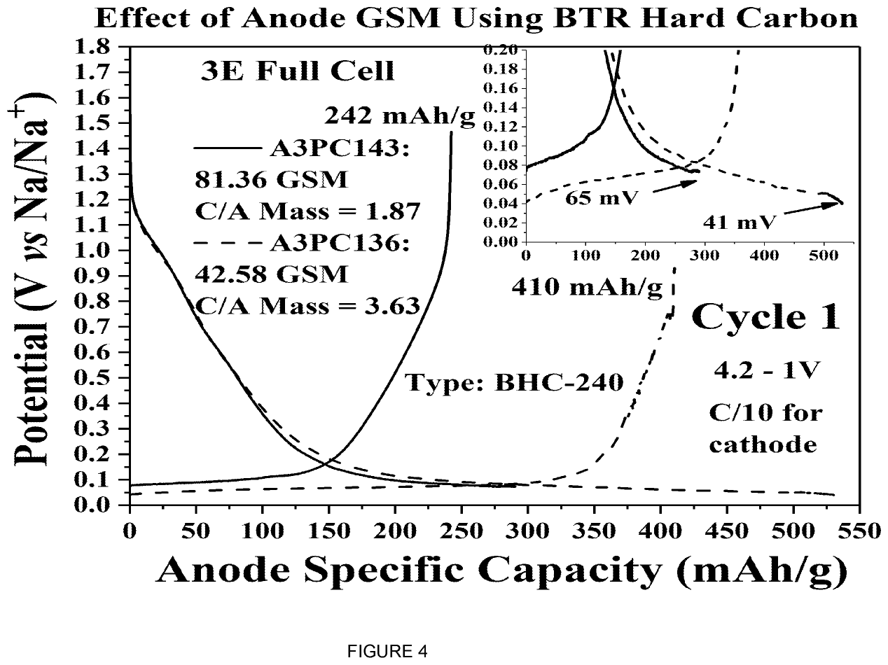

FIG. 4 again confirms that the anode capacity profile of the first cycle (410 mAh/g) is higher in the case of the 3E full cell that contains the lower mass of anode material (42.58 gm⁻²) and higher C/A mass balance value (3.63) as compared against the anode capacity (242 mAh/g) for the cell with the higher mass of anode material (81.36 gm⁻²) and the lower C/A mass balance value (1.87).

It is believed that these results demonstrate that the nature of the hard carbon used as the anode active material has no bearing on anode capacity performance.

The Effect of Using Different Binders in the Anode on Anode Active Material Capacity.

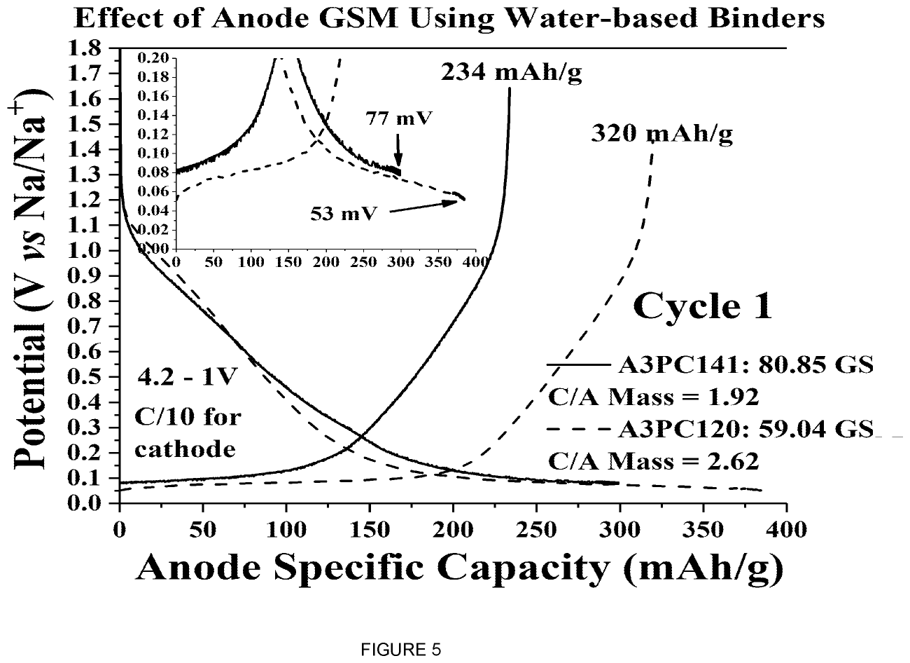

This experiment investigates whether anode capacity is affected by using an aqueous based carboxymethyl cellulose (CMC):styrene butadiene rubber (SBR) binder in place of a non-aqueous PVdF binder in 3E full cells. Two cells were prepared, one (A3PC120) using a hard carbon anode with 59.04 gm⁻² of active anode material and a C/A mass balance of 2.62 and the other (A3PC141) using a hard carbon anode with 80.85 gm⁻² of active anode material and a mass balance of 1.92. In all other aspects, i.e. the use of an aqueous binder based on CMC and SBR, the choice of cathode, and the choice of commercial hard carbon anode (available, for example, from Kuraray Corporation), the two cells were identical. As shown in FIG. 5, the heavier cell with 80.85 gm⁻² of anode active material was able to deliver 234 mAh/g in the first discharge cycle of the full cell, while the cell with the lighter mass of anode active material (59.04 gm⁻²) delivered 320 mAh/g. Thus, it is concluded that the enhanced capacity of hard carbon in cells that use a lower mass of anode active material is not affected by the type of binder used and it is expected that any binder type will show this trend.

Long Term Cycling Results for 3E Full Cells of the Present Invention.

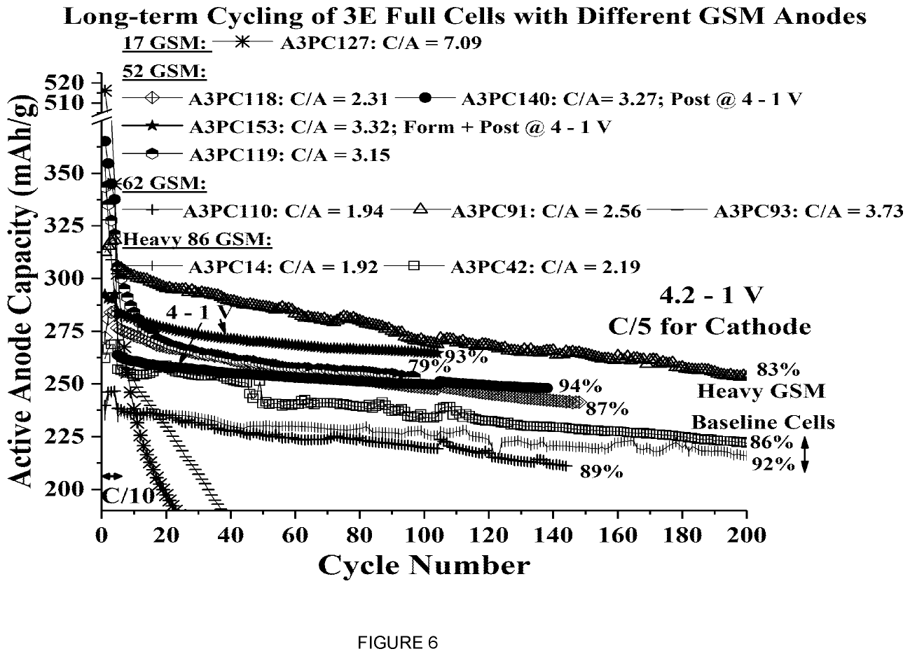

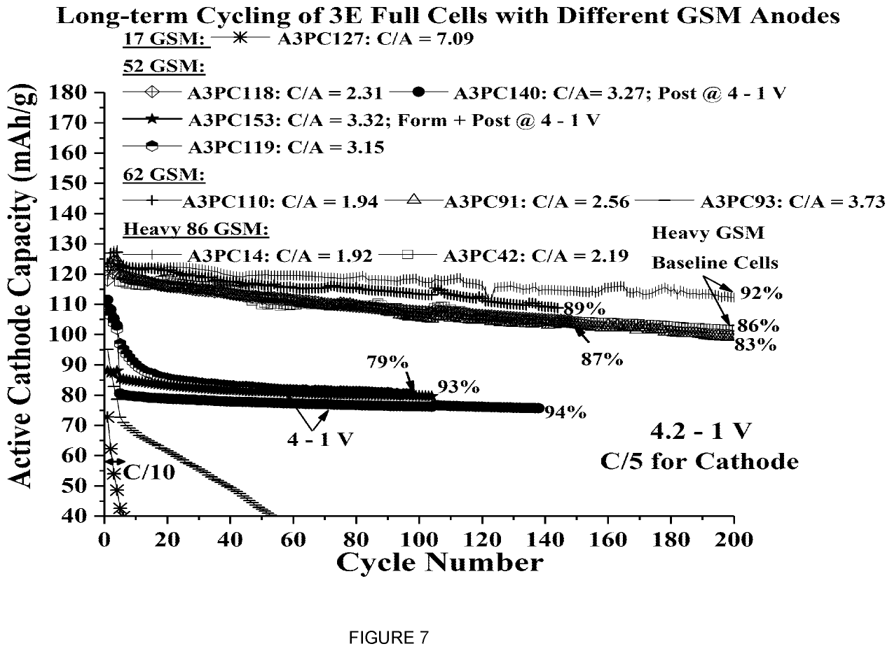

FIGS. 6 and 7 illustrate the long-term cycling performance for several of the 3E full cells with different masses of anode active material which are detailed above in Table 1. Specifically, FIG. 6 displays the capacity vs cycle life based on active anode's specific capacity and FIG. 7 presents corresponding graphs for active cathode specific capacity. All of the cells underwent the first 4 cycles at C/10 (the ‘formation’ cycles) before cycling at C/5 (Post-formation cycling). It will be noted that FIGS. 6 and 7 also detail the capacity retention of the last cycle (vs the 5^{th} cycle capacity or the 1^{st} ‘Post’ cycle capacity) for selected cells.

Several trends can be identified from the results presented in FIGS. 6 and 7 and Table 1 above:
Light GSM anodes (for example, GSM values of around 52 or 62) with lower C/A mass balances (i.e. C/A mass balances of 1.9 to 2.56) promote greater cycling stabilities as opposed to with higher C/A mass balances (i.e. C/A mass balance greater than 3.0); for 52 GSM anodes, compare cycling stabilities of A3PC118 with that of A3PC119 while for the 62 GSM anodes, compare cycling stabilities of A3PC110 and A3PC91 with that of A3PC93.
For any light GSM anode (for example, GSM values of around 52 or 62), the cathode specific capacity increases when the C/A mass balance is lowered (compare A3PC118 with A3PC119 and A3PC110 or A3PC91 with A3PC93).
The above observations are rooted in the lower coulombic efficiencies observed for light GSM anodes as a result of deeper sodiation of the hard carbon when heavier C/A mass balances are used. Due to this reason, cells using very low GSM anodes (less than 30 GSM) with high C/A mass balances (greater than around 5) tend to display very poor first cycle coulombic efficiencies (under 50-60%) and this is the reason for such cells displaying poor cathode capacities and also cycling stabilities. For example, A3PC127 using 17.11 GSM anode and 7.09 C/A mass balance delivered just 72.8 mAh/g cathode capacity in the first discharge cycle.

The Effect of Altering the Rating of the Formation Voltage Window on Cycling Stability and Anode Specific Capacity.

This experiment investigates the effects of “de-rating” the formation voltage window on the cycling stability and anode specific capacity

Cell A3PC140 containing 51.64 gm⁻² of active anode material at a thickness of 66 μm and a C/A mass balance of 3.27 was cycled 4 times at C/10 at 4.20-1.00 V (during the formation cycles) and then cycled at 4.00-1.00 V at C/5 (Post-formation cycling). As shown in FIGS. 6 and 7, following “de-rating” in the ‘Post’ cycles, this cell shows very high stability over 134 ‘Post’ cycles, with a cathode capacity retention of 94%.

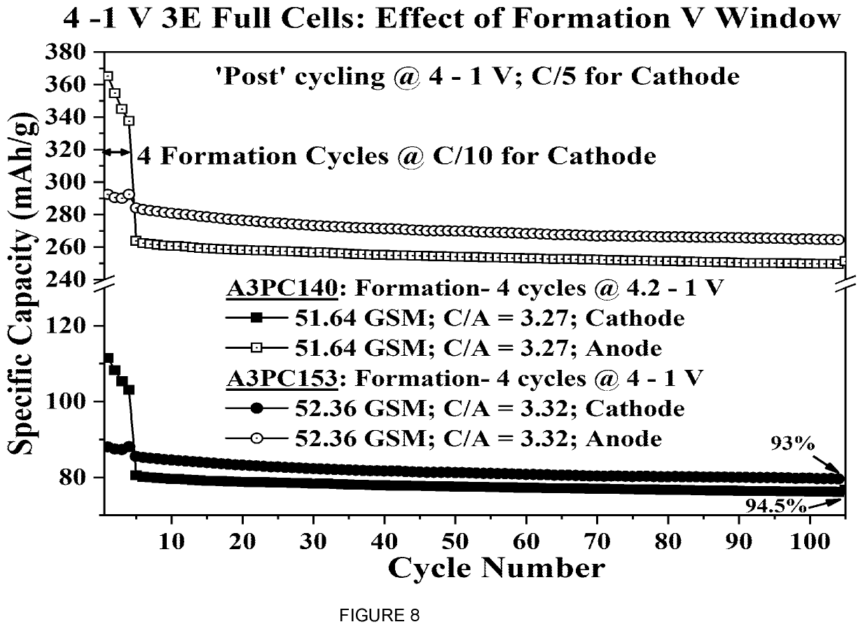

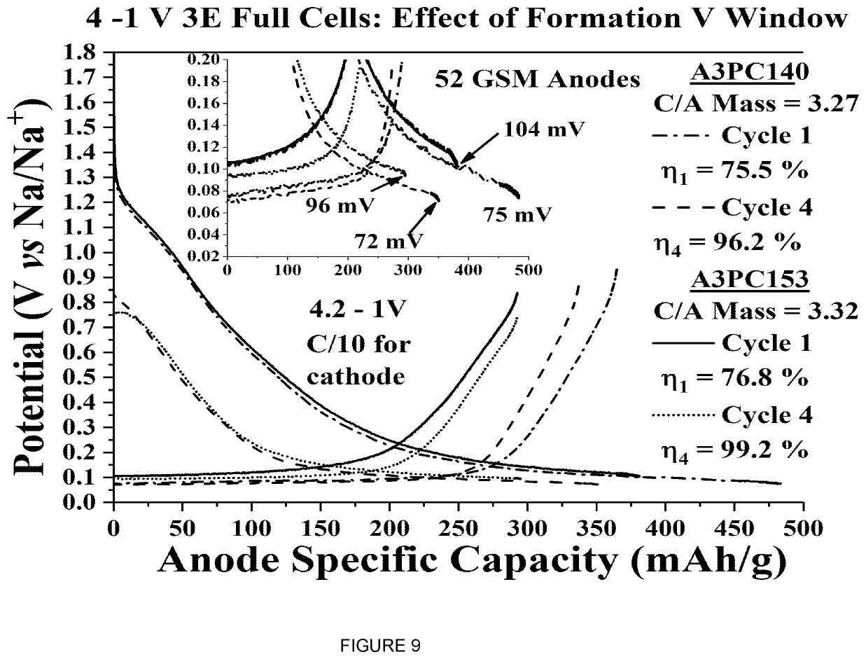

In order to investigate further the effect of de-rating and also the formation protocol, another similar cell, A3PC153, containing 52.36 gm⁻² of active anode material at a thickness of 66 μm and a C/A mass balance of 3.32 was fabricated and then cycled 4 times at C/10 at 4.00-1.00 V during a formation process, and then at the same voltage 4.00-1.00 V but at C/5 during a ‘Post’ cycling process. The rationale behind this experiment was to investigate the effects of 4 formation cycles at 4.20-1.00 V vs that of 4 formation cycles at 4.00-1.00. FIGS. 8 and 9 provide the respective cathode and anode capacities obtained vs cycle number and also the anode profiles for the 1^{st} and the 4th formation cycles. FIG. 8 also mentions the capacity retention of the 100^{th} ‘Post’ cycle (vs the 1^{st} ‘Post’ cycle capacity). The following can be observed from the results:
Employing 4 formation cycles at 4.00-1.00 V significantly improves cathode and anode capacities when these cells are then ‘Post’ cycled, as compared against using 4 formation cycles at 4.20-1.00 V (cathode: 85.5 vs 80.5 mAh/g; anode: 284.1 vs 264.8 mAh/g), at similar cycling stabilities in the ‘Post’ cycling (about 93 or 94.5% retention in 100 ‘Post’ cycles).
The anode profiles in FIG. 9 indicate the deleterious effect that formation at 4.20-1.00 V has on delivered capacities. It is believed that the reason for this is due to the 4.20-1.00 V leading to greater sodiation of the anode at the fully charged state, and this, in turn, adversely affects the coulombic efficiency of light GSM anodes. As FIG. 9 shows, the coulombic efficiency increases from 75.5% in cycle 1 of the A3PC140 cell (subjected to 4 formation cycles at 4.20-1.00 V) to only 96.2% at cycle 4, whereas cell A3PC153 (subjected to 4 formation cycles at 4.00-1.00 V) firstly displays a marginally higher coulombic efficiency in the first cycle (76.8%) but also a significantly improved efficiency of 99.2% in the fourth cycle. It is believed that this last observation is as a result of a reduced Na loss from the cathode when the lower 4.00-1.00 V cell formation voltage is used, and this might explain why a first higher ‘Post’ discharge capacity of the cathode (and hence, the anode) was also observed.

From the above results it is concluded that de-rating light GSM anodes firstly from 4.20-1.00 V (during formation cycling) to 4.00-1.00 V (during ‘Post’ cycling) and further using 4.00-1.00 V for both formation and ‘Post’-formation cycling, provides a good strategy for enhancing cycling stability: the 4.00-1.00 V cycling is quite stable and the delivered capacity in the ‘Post’ cycling is higher if formation is also conducted from 4.00-1.00 V. By employing such de-rating cycling protocols, one could use heavier C/A mass balances (>3) even with light GSM anodes.

Long Term Cycling Stability for a Cell According to the Present Invention.

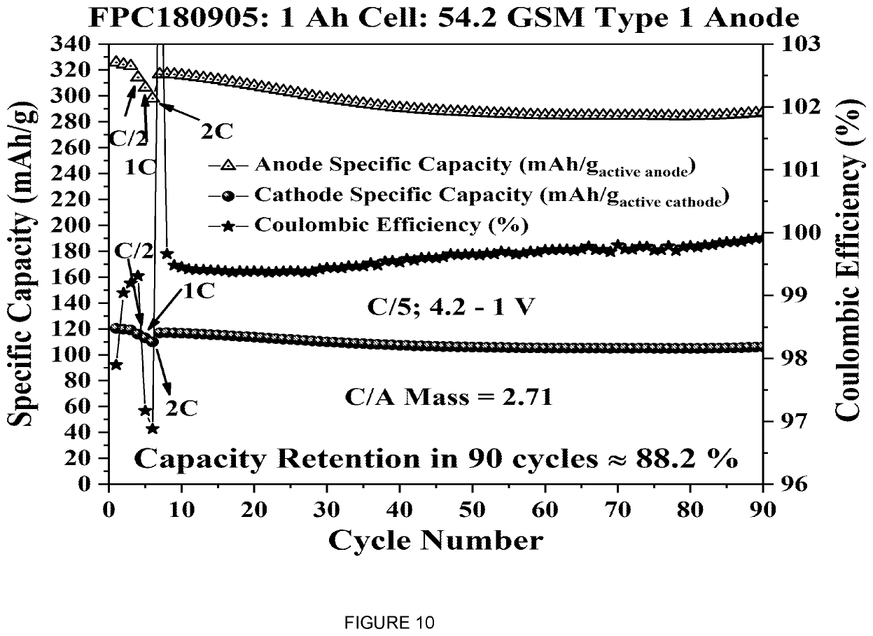

FIG. 10 is a graph of specific capacity against cycle number for the 1 Ah full cell FPC180905 which contains a mass of active anode material (commercially available, for example, from Kuraray Corporation) of 54.20 gm⁻², an anode material thickness of 65 μm and has a C/A mass balance of 2.71. As FIG. 10 shows, this cell has a high anode specific capacity of 325.71 mAh/g, 88.2% of which is retained after 90 cycles, consequently, this cell has extremely high cycling stability.

The Effect of Altering C/A Anode Mass Balance on Specific Energy.

The following table provides various relevant metrics for all the 1 Ah cells tested using light GSM anodes (active anode GSMs around 50-54) compared against a heavy GSM anode of 97.23. The energy density stated is that for the 1^{st} ‘Post’ cycle (after 4 formation cycles). Different cells were cycled at different voltage windows as indicated. As these results show, the energy density for cells of the present invention which contain light GSM anodes consistently out-perform the cell that contains the heavy (>80 gm⁻²) mass of anode active material.

TABLE 2

| | | | Energy | |
|---|---|---|---|---|
| | Anode | C/A | Density | |
| Cell | GSM | Mass | (Wh/kg) | Voltage Window |
| FPC171230 | 97.23 | 1.36 | 101.00 | ‘Formation’ & ‘Post’ |
| (heavy | | | | cycling at 4.20-1.00 V |
| anode GSM) | | | | |
| FPC181105 | 52.64 | 2.25 | 120.90 | ‘Formation’ & ‘Post’ |
| | | | | cycling at 4.20-1.00 V |
| FPC181106 | 52.80 | 2.25 | 101.70 | ‘Formation’ & ‘Post’ |
| | | | | cycling at 4.10-1.00 V |
| FPC181131 | 52.76 | 2.25 | 122.61 | ‘Formation’ & ‘Post’ |
| | | | | cycling at 4.20-1.00 V |
| FPC180905 | 54.20 | 2.71 | 118.29 | ‘Formation’ & ‘Post’ |
| | | | | cycling at 4.20-1.00 V |
| FPC181107 | 52.84 | 2.79 | 108.25 | ‘Formation’ & ‘Post’ |
| | | | | cycling at 4.10-1.00 V |
| FPC181129 | 52.79 | 2.81 | 110.26 | ‘Formation’ at 4.15-1.00 |
| | | | | V; ‘Post’ at 4.10-1.00 V |
| FPC181130 | 52.91 | 2.81 | 107.95 | ‘Formation’ & ‘Post’ |
| | | | | cycling at 4.10-1.00 V |
| FPC181010 | 52.92 | 2.84 | 133.23 | ‘Formation’ & ‘Post’ |
| | | | | cycling at 4.20-1.00 V |
| FPC181009 | 52.73 | 2.85 | 103.65 | ‘Formation’ at 4.20-1.00 |
| | | | | V; ‘Post’ at 4.00-1.00 V |
| FPC180916 | 50.30 | 2.96 | 133.98 | ‘Formation’ & ‘Post’ |
| | | | | cycling at 4.20-1.00 V |

Further Study into the Effects of the Mass of Anode Active Material and C/A Anode Mass Balance on Initial Cycling Stability

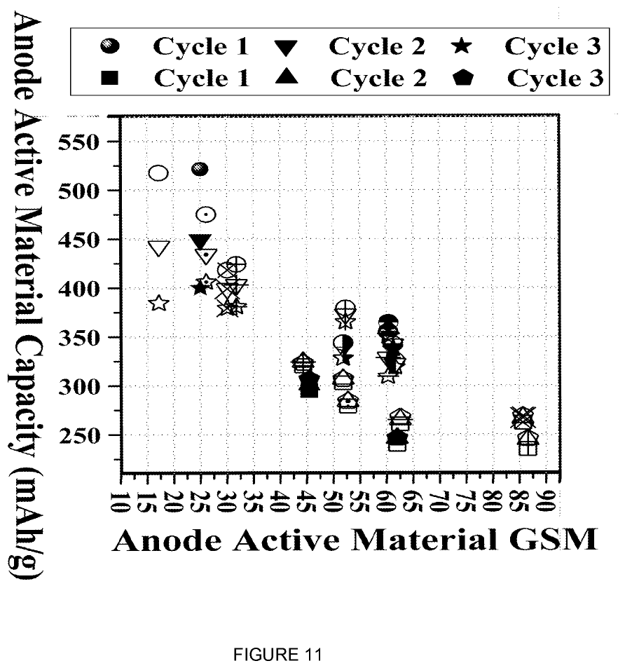

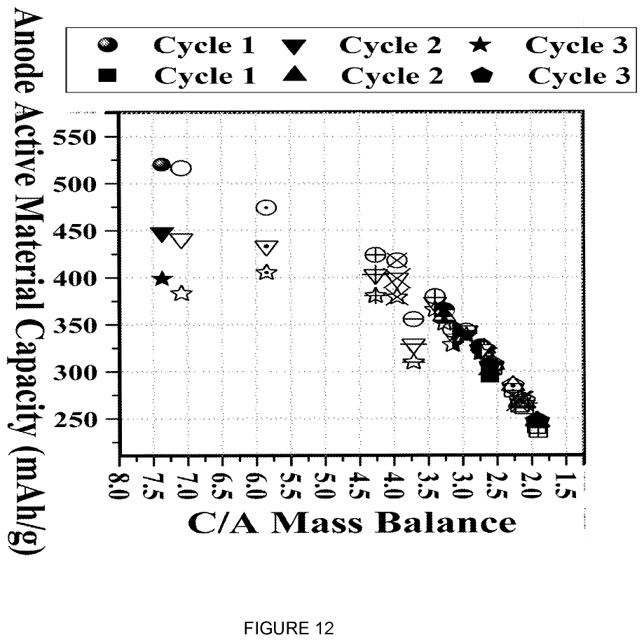

In view of the experimental results presented above, it is clear that cells that contain a low mass anode are highly advantageous for providing high anode capacities, however, such cells do not necessarily provide the best initial cycling stability during the formation process. This observation is clearly illustrated in FIG. 11 which shows that for very low mass anodes, particularly less than around 30 gm⁻², the cells have the lowest cycling stability over the first three cycles, whereas higher mass anodes are considerably more stable. Further, as illustrated by FIG. 12, C/A mass balance also has a bearing on the initial cycling stability over the first three cycles. For the same cells tested in FIG. 11, those with a mass balance of around 7.5 and 6.0 (the cells with an anode mass of less than around 30 gm⁻²) exhibit the lowest initial cycling stability, whereas the stability is improved for cells with a mass balance of around 3.5 or less.

FIGS. 11 and 12 may also be used to identify that there are optimum ranges for anode mass and C/A mass balance in order to produce cells with high anode capacity (preferably at least 270 mAh/g) and excellent initial cycle stability. Specifically, a cell with an anode mass of between 45 gm⁻² and 75 gm⁻² and a C/A mass balance of around 2.0 to 3.5 is particularly favourable.

Investigation of the Performance of a Cell which Contains a Non-Nicekalte Cathode Active Material

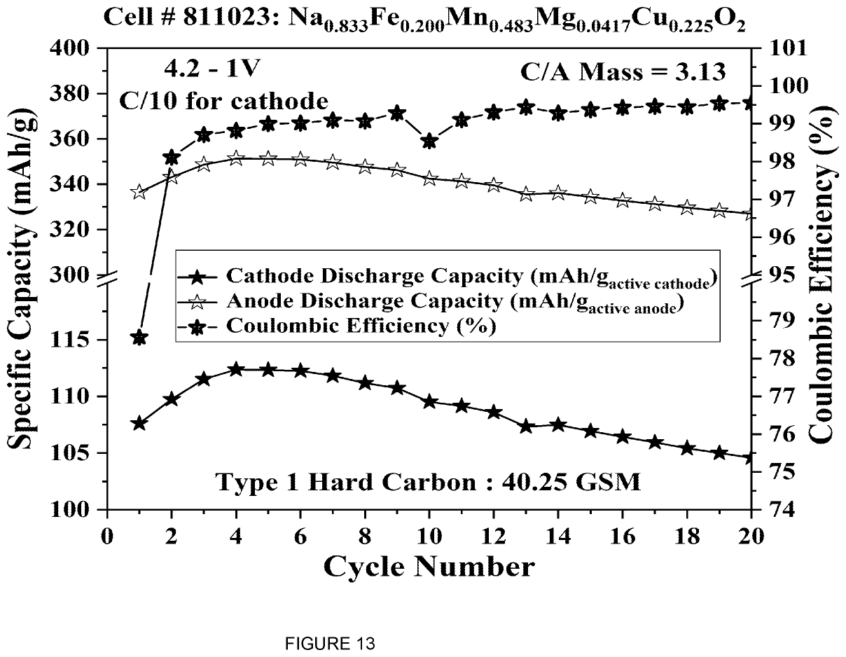

As detailed in Table 1 above cell 811023 contains Na_{0.833}Fe_{0.200}Mn_{0.483}Ma_{0.0417}CU_{0.225}O₂ as the cathode active material, a Type 1 hard carbon anode of mass 40.25 gm⁻² and a C/A mass balance of 3.13. FIG. 13 shows a graph of specific capacity against cycle number, and demonstrates that a non-nickelate cathode active material when used in a cell according to the present invention performs extremely well achieving a first desodiation capacity of 336.45 mAh/g and retaining 97.2% of this after 20 cycles.

This result proves that the favourable effect of increasing anode specific capacities with decreasing anode GSMs is independent of the type of cathode used.

Investigation into the Effect of a Hard Carbon/Fe₂P Anode on Anode Capacity Performance.

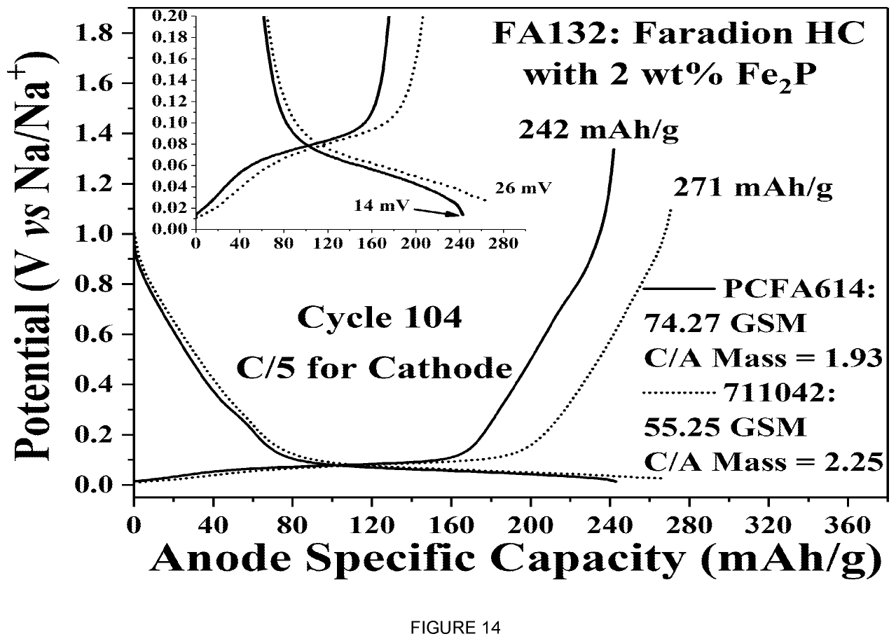

It was investigated whether hard carbon composite anodes (hard carbon mixed with ‘X’ as detailed above) also show the trend of increasing anode specific capacities with decreasing anode GSMs. In this example, another type of hard carbon was used prepared from corn starch (called ‘Faradion hard carbon’). The composition of cells PCFA614 and 711042 which use differing amounts of HC/Fe₂P anode active material, 74.27 gm⁻² and 55.25 gm⁻² respectively, is detailed in Table 1 above. FIG. 14 shows a plot of potential (V versus Na/Na⁺) against the anode specific capacity (mAh/g) for the cycle 104 performance of these two cells. This Figure not only confirms the general trend discussed above concerning lower mass anodes producing higher anode capacities, but it also demonstrates that such hard carbon/Fe₂P (HC/X) anodes produce cells with extremely high cycling stability. From these results, it is clear that the trend of increasing anode capacities with decreasing anode GSMs will be shown by different types of hard carbon/X composite anodes.

Investigation into the Effect of a Cathode/Anode Mass Balance of Below 1.0 and of Using a Non-Nickelate Cathode Material

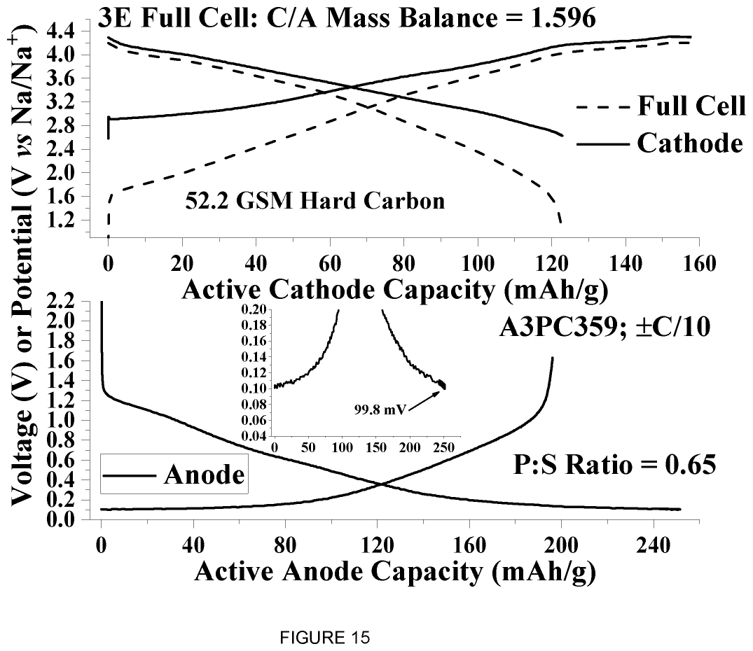

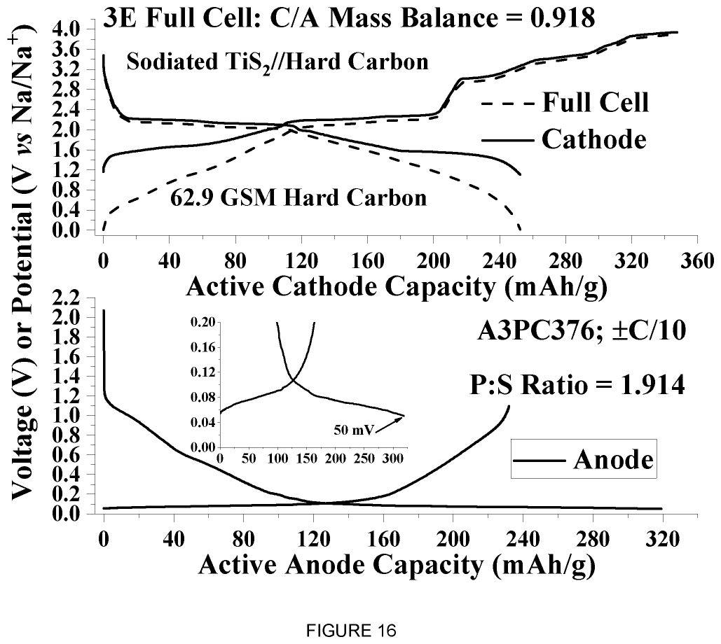

As shown in FIGS. 15 and 16, the anode profiles in 3E full cells using low masses (GSMs) of hard carbon material (for example commercially available from Kuraray Corporation) and with low C/A mass balances (Sample 50, C/A=1.596 and Sample 51, C/A=0.918). Both of the cells used 0.5 m NaPF₆ in EC:DEC:PC=1:2:1 wt/wt as the electrolyte. The results not only again confirm that such light GSM anodes deliver excellent capacity, but also that other non-nickelate materials such as the sodiated metal sulphide material (TiS₂) can be employed as the active cathode material. This example also reiterates that C/A mass balance, when used in such batteries, is highly dependent on the cathode and anode active material used (as such, the respective capacities of the cathode and anode active materials really dictate what range of C/A mass balances can be used).

Investigation into the Effect of Using an Oxygen-Deficient Nickelate Cathode Material

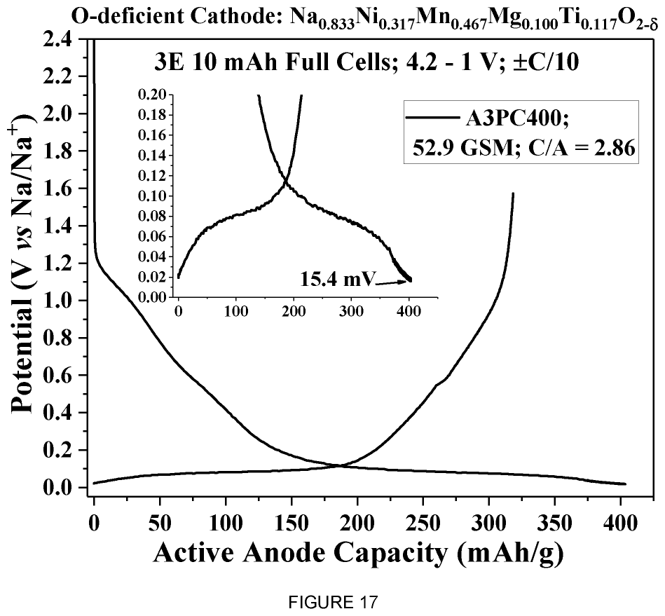

FIG. 17 illustrates a plot of potential (V versus Na/Na⁺) against the anode specific capacity (mAh/g) for a cell using an oxygen-deficient nickelate cathode material. In line with the other cells according to the present invention, the anode GSM is ≤80 g/m² (i.e 52.9) and the C/A ratio is in the range 0.1 to 10 (i.e. 2.86), and as will be observed, a cell with an oxygen deficient nickelate cathode material performs in an analogous manner to a cell using a fully oxygenated nickelate cathode material,

Investigation to Show the Charge Acceptance Capability of Low Gsm Anode-Based Cells

FIG. 17 shows the capacity retention vs cycle number of 3E full cells when charged at various rates as shown and discharged at a constant C/5 rate. These cells used either low GSM (Samples 54 and 56) or comparative GSM anodes (Samples 53 and 55) of either a hard carbon commercially available from Kuraray Corporation or a hard carbon commercially available from BTR (grade BHC-240). Comparing the two hard carbon-containing cells, it is observed that the low GSM anode cell (A3PC268) according to the present invention displays better capacity retention at fast charge rates such as 2C than the comparative GSM cell (A3PC231). This trend is also seen for the hard carbon material available from BTR. In addition, the low GSM cell (A3PC238) according to the present invention can cycle in a much more stable fashion if charged at fast rates such as 2C than the corresponding comparative GSM anode cell (A3PC225).

This example reveals another surprising and very important and commercially relevant result for low GSM anodes, i.e. that the cells of the present invention are able to be charged more quickly than the comparative cells which contain a GSM of anode material greater than 80.

Investigation into the Relationship Between the Weight of Anode Material (Gsm) and I) Porosity of the Anode Material and II) the Volume Specific Surface Area of the Anode Material

X-ray computed tomography (CT) is a useful tool to construct 3D images of the interior of battery electrodes in a non-destructive fashion. By constructing such 3D mapped images, CT allows visualisation and quantification of a battery material's morphology at the electrode level. In particular, it can reveal two important physical parameters about a battery electrode firstly, its porosity, this can be determined in units of % (defined as the ratio of the void volume within the electrode to the total volume of the electrode), and secondly its volume specific surface area, VSSA, which is determined in units of m²/m³.

As the above results demonstrate, the low GSM effects of hard carbon are not brought about as a result of changes to the active material (type of hard carbon), binder or electrolyte, but (when the thickness of the anode material is less than 100 μm and the C/A is in the range 0.1 to 10) only as a result of the GSM of the hard carbon used in the anode electrode. The present applicant now investigates how the porosity and VSSA of the hard carbon electrode changes with its GSM and as discussed below, has obtained interesting and completely unexpected results.

CT measurements were conducted on two samples:

As detailed in Table 3 below, the sample described as comparative Sample 57 uses 99.09 GSM anode active and a coating thickness of 113 μm.

The sample described as Sample 58 is in accordance with the present invention and uses 52.91 GSM anode active and coating thickness of 60 μm.

To avoid any confusion, please note that for both these samples, CT measurements were conducted on the hard carbon electrodes (not when in an electrochemical cell).

Table 3 Below Summarises the Results of the CT Scans:

TABLE 3

| | | Coating thickness | | |
|---|---|---|---|---|
| | Anode Active | excluding current | Porosity | VSSA |
| Sample | GSM (g/m2) | collector foil (μm) | (%) | (μm²/μm³) |
| 57* | 99.09 | 113 | 28 | 0.72 |
| 58 | 52.91 | 60 | 31 | 1.38 |

As the above results show, sample 58 exhibits a VSSA value which is almost double (1.92) that of the comparative sample 57. This enhanced VSSA value helps explain the much higher capacities seen for all low GSM hard carbon electrodes according to the present invention. It appears that the higher capacities for the low GSM anodes are due to their enhanced surface area per unit volume which simply means more of the hard carbon active material is accessible for sodium storage. In other words, the electrolyte-hard carbon interfacial area is enhanced for low GSM anodes and this access to ‘more’ hard carbon active material per given volume results in higher sodium storage capacity of the electrode.

It is important to note that although the VSSA for samples 57 and 58 are markedly different, these two samples do not significantly differ in their porosities this is a highly unexpected result as studies in the literature tend to indicate that differences in porosities (by techniques such as BET on the hard carbon powder) provide an explanation as to why different hard carbons have different capacities (and also differing plateau:slope capacity ratios). However, the present Applicant's results from the above described CT experiment indicate that it is not the porosity that is the critical feature, but the VSSA, and that it is this which can largely define the capacity delivered by a hard carbon electrode as well as the ratio of its plateau:slope capacities. It will be appreciated by anyone skilled in the art that the porosity of a hard carbon electrode is still important as it determines certain electrochemical performance aspects such as first cycle efficiency, density of the electrode etc; but, as seen in this example, VSSA is also an extremely important parameter which this patent has revealed here for the first time.

Based on simple linear interpolation, for an anode active GSM of 80 GSM (the threshold GSM value for the samples used in cells of the present invention), the VSSA value would be 0.993. However, it should be appreciated that there might be some tolerance in this VSSA value which might change slightly or even significantly with the type of hard carbon. Also, it is expected that the type of carbon additive and binder can influence the VSSA values, and it is expected that it might also influence such VSSA values significantly. As such, therefore, the present invention relates to any negative electrode active material (preferably disordered carbon and further preferably hard carbon)-containing electrode with a VSSA value above 0.80 for the active material layer.

1. A sodium-ion secondary cell comprising a cathode, an anode, and an electrolyte comprising sodium tetrafluoroborate (NaBF₄) or sodium hexafluorophosphate (NaPF₆), wherein the cathode comprises one or more positive electrode active materials, and the anode comprises a layer of a negative electrode active material disposed on an anode substrate; wherein the negative electrode active material comprises one or more disordered carbon-containing materials wherein:
i) a mass of the layer of the negative electrode active material is ≤80 g per square metre of the anode substrate;
ii) a ratio of a mass of the positive electrode active material to the mass of the layer of negative electrode active material is from 0.1 to 10; and
iii) a thickness of the layer of negative electrode active material on the anode substrate is ≤100 μm.

2. The sodium-ion secondary cell according to claim 1 wherein the mass of the layer of the negative electrode active material per square metre of the anode substrate is greater than 25 gm⁻² to less than 80 gm⁻².

3. The sodium-ion secondary cell according to claim 1, wherein the mass of the layer of the negative electrode active material per square metre of the anode substrate is from 40 gm⁻² to 75 gm⁻².

4. The sodium-ion secondary cell according to claim 1, wherein the ratio of the mass of the positive electrode active material to the mass of the layer of the negative electrode active material is from 0.5 to 10.

5. The sodium-ion secondary cell according to claim 1 wherein the thickness of the layer of the negative electrode active material on the anode substrate is ≤80 μm.

6. The sodium-ion secondary cell according to claim 1, wherein the one or more of the positive electrode active materials is a compound of the general formula:
A_{1+δ}M¹_{V}M²_{W}M³_{X}M⁴_{Y}⁵_{Z}O_{2-c}
wherein
A is one or more alkali metals selected from sodium, potassium and lithium;
M¹ comprises one or more redox active metals in oxidation state +2,
M² comprises a metal in oxidation state greater than 0 to less than or equal to +4;
M³ comprises a metal in oxidation state +2;
M⁴ comprises a metal in oxidation state greater than 0 to less than or equal to +4;
M⁵ comprises a metal in oxidation state +3;
wherein
0≤δ≤1;
V is >0;
W is ≥0;
X is ≥0;
Y is ≥0;
at least one of W and Y is >0
Z is ≥0;
C is in the range 0≤c<2
wherein V, W, X, Y, Z and C are chosen to maintain electrochemical neutrality.

7. The sodium-ion secondary cell according to claim 1, wherein a structure of the one or more disordered carbon-containing negative electrode active material is a non-graphitizable, non-crystalline amorphous structure.

8. The sodium-ion secondary cell according to claim 1, wherein the negative electrode active material comprises hard carbon.

9. The sodium-ion secondary cell according to claim 1, wherein the negative electrode active material comprises a hard carbon/X composite, wherein X is one or more selected from phosphorus, sulfur, indium, antimony, tin, lead, iron, manganese, titanium, molybdenum and germanium, present in an elemental form or in a compound form.

10. The sodium-ion secondary cell according to claim 1, wherein the negative electrode active material comprises one or more further materials which are capable of storing sodium ions, selected from a non-metal, a non-metal-containing compound, a metal, a metal-containing compound and a metal containing alloy.

11. The sodium-ion secondary cell according to claim 1, wherein the layer of the negative electrode active material disposed on the anode substrate has a volume specific surface area (VSSA) of above 0.8.

12. A method of manufacturing the sodium-ion secondary cell according to claim 1, comprising:
a. assembling a cathode comprising one or more positive electrode active materials, together with an anode comprising an anode substrate coated with a layer of negative electrode active material, and an electrolyte comprising sodium tetrafluoroborate (NaBF₄) or sodium hexafluorophosphate (NaPF₆), to form a sodium-ion secondary cell; and
b. cycling the sodium-ion secondary cell to a first voltage; wherein
i) a mass of the layer of negative electrode active material per square metre of the anode substrate is ≤80 gm⁻²,
ii) a ratio of a mass of the positive electrode active material to the mass of the layer of negative electrode active material is from 0.1 to 10, and
iii) a thickness of the layer of negative electrode active material on the anode substrate is ≤100 μm.

13. A battery comprising at least two sodium-ion secondary cells according to claim 1.

14. The sodium-ion secondary cell according to claim 1, wherein the layer of the negative electrode active material disposed on the anode substrate is uniform and has a volume specific surface area (VSSA) of above 0.8.
